(19) United States
(12) Patent Application Publication
(10) Pub. No.: US 2004/0012956 A1
(43) Pub. Date: Jan. 22, 2004

(54) Light bar for decorative lamp strip

(76) Inventor: Hsien-Te Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/196,253

(22) Filed: Jul. 17, 2002

(51) Int. Cl. F21V 1/00

(52) U.S. Cl. 362/240; 362/249; 362/558

(57) ABSTRACT

An improved lamp strip includes a light bar defining a plurality of vertical bores spaced from each other along the bar. The light bar comprises a slit extending in an axial direction along the light bar and facing to the bores, which is easy to be pushed opened for the installation of light emitting elements into the light bar. A plurality of light emitting elements are vertically received in the bores of the light bar. A colorful layer having colorful patterns is further covered over the light bar. A light-transmitting outer tube is then covered over the colorful layer. The light emitting from the light emitting elements is projected through the colorful layer and the outer tube.

### BACKGROUND OF THE INVENTION

1. Field of the Invention

The present invention relates generally to a lamp strip, and in particular to an improved light bar for decorative lamp strip.

2. Description of the Prior Art

Lamp strips, which is flexible and can be wound around or hang on trees, windows and etc., are commonly used for decoration. Some lamp strips provide a mild illumination to the surrounding and are especially suitable for use e.g. in party; some lamp strips, which have flashing bulbs, are very fancy and attractive, and are popularly used e.g. in X'mas.

Examples include U.S. Pat. No. 6,244,726 B1 wherein a lamp strip comprising a light bar which has a plurality of bulb-holders and sockets is disclosed. However, the light bar has to be perforated to provide a plurality of holes for receiving the bulbs and sockets. Therefore, the strength of light bar is inevitably weakened. Also, the production cost is increased as extra works are required for making socket holes in the light bar and putting in the joints in the sockets.

Moreover, the transparent covering surrounding the light bar and the bulbs functions only for protection and water resistance, and provides no decorative purposes. Color of the light emitted from the bulbs cannot be changed unless the bulbs are changed.

It is thus desired to provide a lamp strip having a hollow light bar which is easy to produce and enables the simply installation of bulbs, and also has colorful pattern.

### SUMMARY OF THE INVENTION

An object of the present invention is thus to provide an improved lamp strip having a hollow light bar with slit which enables easy installation of light emitting elements.

Another object of the present invention is to provide an improved light bar which eliminates sockets or conductive elements for wires of light emitting elements, and thereby reduces the production cost.

A still further object of the present invention is to provide a lamp strip with beautiful light patterns.

To achieve the above objects, in accordance with the present invention, there is provided a lamp strip including a light bar defining a plurality of vertical bores spaced from each other along the bar. A slit extending in an axial direction along the light bar and facing to the bores. The slit is easy to be pushed opened for the installation of light emitting elements into the light bar. A plurality of light emitting elements is vertically received in the bores of the light bar. A colorful layer having colorful patterns is further covered over the light bar. A light-transmitting outer tube is then covered over the colorful layer. The light emitting from the light emitting elements is projected through the colorful layer and the outer tube.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of an elongate light bar of a lamp strip constructed in accordance with a first embodiment of the present invention;

FIG. 2 is a perspective view showing a number of bores are formed in the light bar;

FIG. 3 is a cross-sectional view taken along line A-A of FIG. 2;

FIG. 4 is an exploded view showing a light string including a plurality of light emitting elements is separated from the light bar of the present invention;

FIG. 5 is a perspective view showing a number of light emitting elements of the light string are mounted in the bores of the light bar;

FIG. 6 is a perspective view showing that an outer tube is further covered over the light bar for protection and water resistance;

FIG. 7 is a perspective and axial sectional view taken along line B-B of FIG. 6, showing each of the bores of the light bar is received with a light emitting element;

FIG. 8 is a perspective view showing the light bar is further covered with a colorful layer and an outer tube in accordance with a second embodiment of the present invention;

FIG. 9 is a perspective and axial sectional view taken along line C-C of FIG. 8, showing each of the bores of the light bar is received with a light emitting elements; and

FIG. 10 is cross-sectional view taken along line D-D of FIG. 8.

### DETAILED DESCRIPTION OF THE PREFERRED EMBODIMENTS

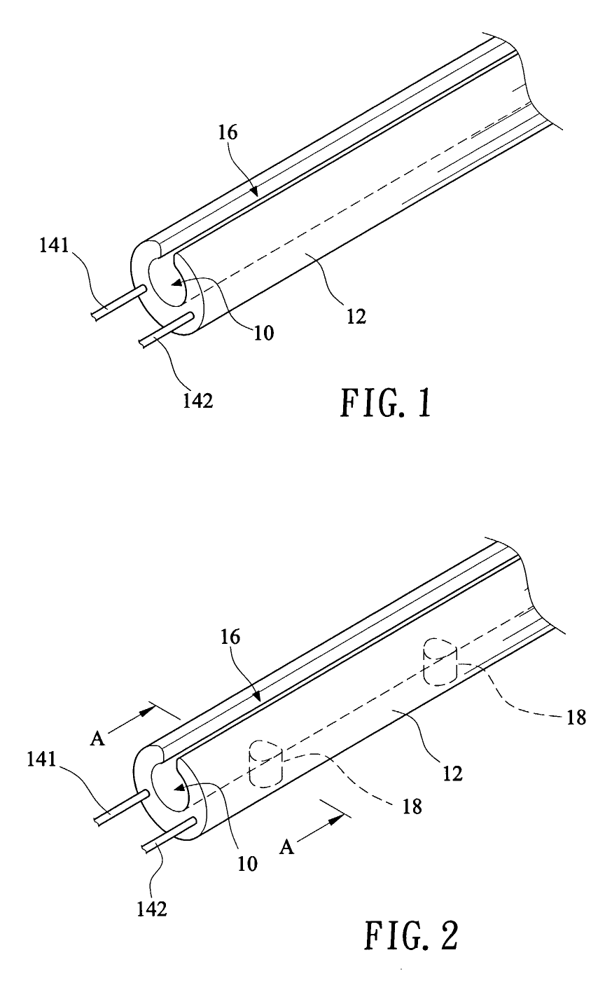

Please refer to FIG. 1, which shows an elongate light bar of a lamp strip constructed in accordance with a first embodiment of the present invention. The light bar, generally designated with reference numeral 12, is made of transparent material, defining an inner space 10 with a slit 16 extending from one end to the other end of the light bar 12. That is, the slit 16 is extended in an axial direction along the light bar 12. Inside the light bar 12, there are a first cable 141 and a second cable 142 running longitudinally along the length of the light bar 12. Electricity provided from a power source is supplied to the light bar 12 via the first cable 141 and the second cable 142.

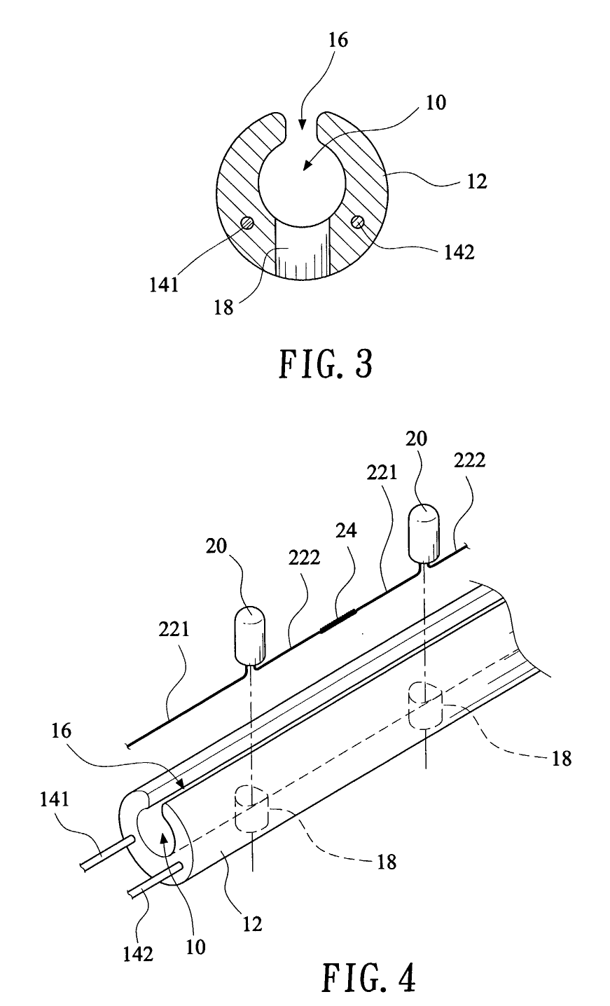

With reference to FIGS. 2 and 3, a plurality of bores 18 are vertically provided in the light bar 12 and spaced along the light bar 12 facing to the slit 16. Each bore 18 can receive and retain a light emitting element or bulb therein. Since the light bar 12 is made of flexible and transparent material, the slit 16 can be easily and simply pushed opened and facilitates the installation of light emitting elements into the light bar 12.

Please refer to FIG. 4. FIG. 4 is an exploded view showing a light string including a plurality of light emitting elements 20 is separated from the light bar 12 of the present invention. Each light emitting element 20 has a first wire 221 and a second wire 222 extended from the bottom end of the light emitting element 20. A part of the second wire 222 of the light emitting element 20 is overlapped and aligned in parallel with the first wire 221 of an adjacent light emitting element 20. The overlapping part of the wires 221, 222 is then twisted to form a lengthy joint 24. Alternatively, a connection element may be used to connect and fix the wires 221, 222 together. Thereby, the light emitting elements 20 are electrically connected in series.

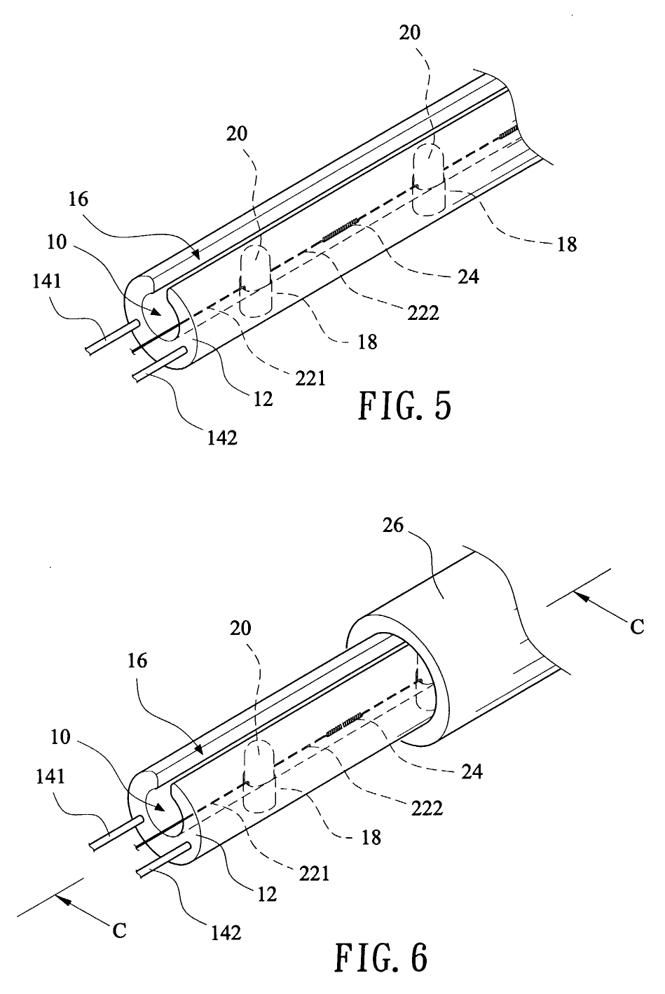

With reference to FIG. 5, it is a perspective view showing a number of light emitting elements 20 of the light string are mounted in the bores 18 of the light bar 12. When the light emitting element 20 is downwardly received in the bore 18 with its bottom end, the wires 221, 222 of the light emitting element 20 and joints 24 between adjacent light emitting elements 20 are received in the inner space 10 of the light bar 12.

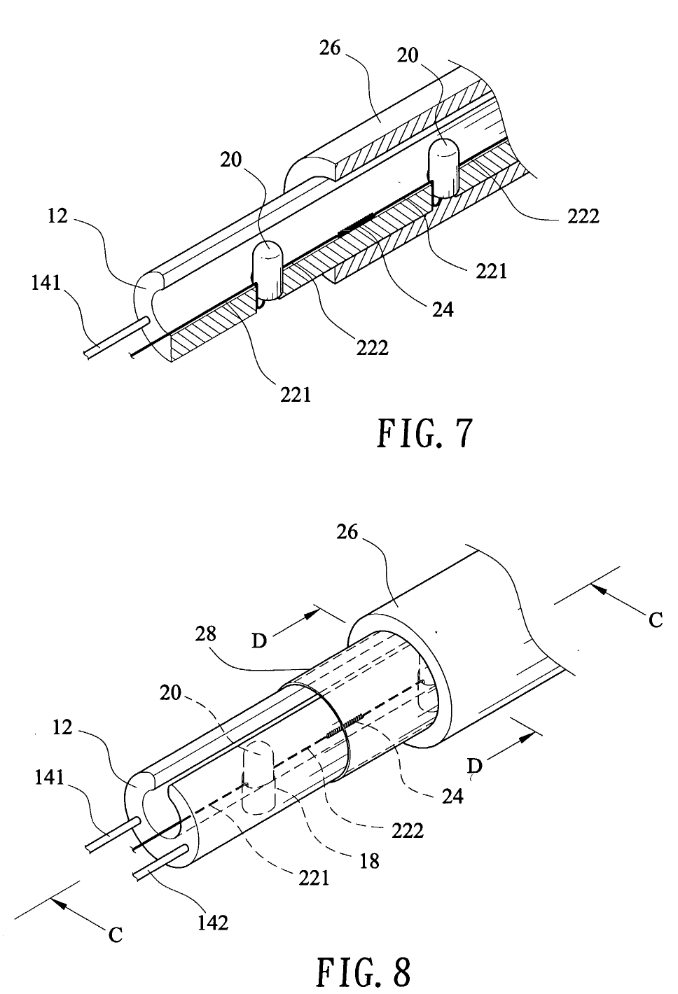

FIG. 6 is a perspective view showing that an outer tube 26 is further covered over the light bar 12 for protection and water resistance. FIG. 7 is a perspective and axial sectional view taken along line B-B of FIG. 6, showing each of the bores 18 of the light bar 12 is received with a light emitting element 20. The outer tube 26 is preferably made of a light-transmitting material, so that the light emitting from the light emitting elements 20 is projected through the outer tube 26.

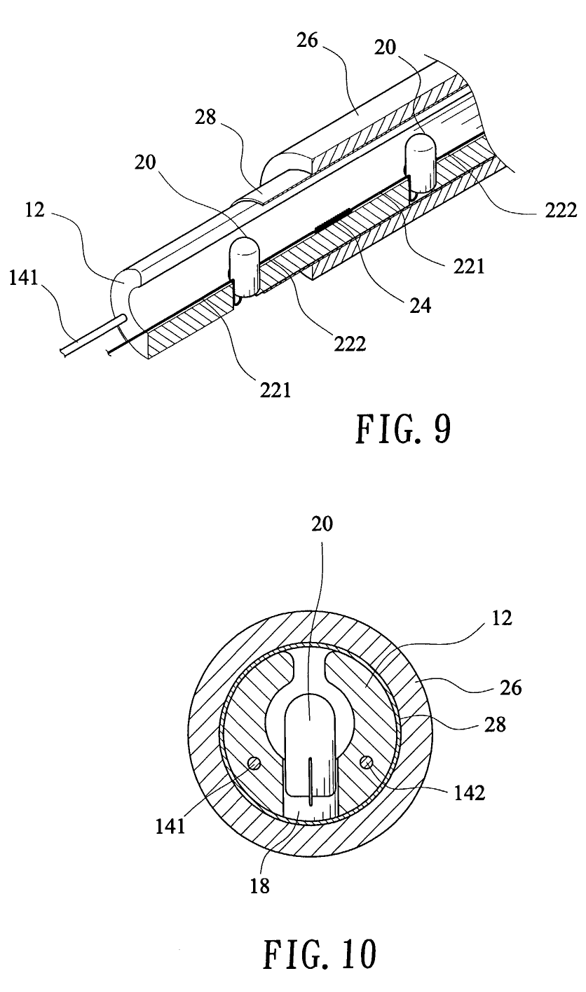

FIG. 8 is a perspective view showing the light bar 12 is further covered with a colorful layer 28 and an outer tube 26 in accordance with a second embodiment of the present invention. FIG. 9 is a perspective and axial sectional view taken along line C-C of FIG. 8, showing each of the bores 18 of the light bar 12 is received with a light emitting elements 20. FIG. 10 is cross-sectional view taken along line D-D of FIG. 8.

The colorful layer 28 is made of light-transmitting and heat-shrinkage material in the form of an elongate light-transmitting inner tube covered over the light bar 12. The outer tube 26 is further covered over the colorful layer 28. The outer tube 26 is preferably made of a light-transmitting material, so that the light emitting from the light emitting elements 20 is projected through the colorful layer 28 and the outer tube 26.

Furthermore, the colorful layer 28 can provide other functions. Preferably, colorful layer 28 comprises a plurality of color patterns or sections along the length of the colorful layer 28. When light from the light emitting elements is projected through the colorful layer 28, it will be turned into different colors according to the color patterns.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A lamp strip comprising:
a light bar defining an inner space therein and having a slit extending in an axial direction along the light bar, a plurality of bores facing to the slit and being vertically formed in the light bar and spaced from each other along the light bar;
a plurality of light emitting elements, a portion of each light emitting element being vertically received in the bore of the light bar; and
an outer tube covered over the light bar.

2. The lamp strip as claimed in claim 1, wherein each of the light emitting elements has a first wire and a second wire extending from a bottom end thereof, and the bottom end of the light emitting element is received in the bore of the light bar.

3. The lamp strip as claimed in claim 1, wherein the light emitting elements are connected in series to form a light string, and the first wire and the second wire are received in the inner space of the light bar.

4. The lamp strip as claimed in claim 1, further comprising a light-transmitting colorful layer formed between the light bar and the outer tube.

5. The lamp strip as claimed in claim 4, wherein the light-transmitting colorful tube is a heat shrinkage tube.
